(19) United States
(12) Patent Application Publication
(10) Pub. No.: US 2025/0029540 A1
(43) Pub. Date: Jan. 23, 2025

(54) DISPLAY APPARATUS AND DISPLAY SYSTEM

(71) Applicant: Sharp Display Technology Corporation, Kameyama City (JP)

(72) Inventors: Tatsuya Hayashi, Kameyama City (JP); Kohji Saitoh, Kameyama City (JP); Kazuhisa Yoshimoto, Kameyama City (JP)

(21) Appl. No.: 18/777,609

(22) Filed: Jul. 19, 2024

(30) Foreign Application Priority Data
Jul. 21, 2023 (JP) 2023-119440

(51) Int. Cl. G09G 3/20

(52) U.S. Cl. CPC G09G 3/2092; G09G 2310/0289; G09G 2310/08; G09G 2330/023

(57) ABSTRACT

A display apparatus includes a power control circuit and a timing control circuit that supplies a timing signal to a level shifter circuit. In response to reception of a control signal used to transition from a display mode to a pause mode from a host controller, the timing control circuit causes the level shifter circuit to stop outputting a gate signal by transmitting a pause signal to the power control circuit and stopping supplying the timing signal to the level shifter circuit. In response to reception of the pause signal, the power control circuit stops supplying at least part of power to be supplied to the display panel and the level shifter circuit while keeping supplying power to the timing control circuit.

### BACKGROUND

### 1. Field

The present disclosure relates to a display apparatus and a display system.

### 2. Description of the Related Art

The display apparatus disclosed in Japanese Unexamined Patent Application Publication No. 2017-91224 performs a control operation in a normal operation mode that displays an image on a display panel or in a sleep mode that does not display images on the display panel. The display apparatus is designed to transition to the sleep mode if no touching operation is performed in the normal operation mode for a predetermined period of time. The display apparatus is also designed to transition to the normal operation mode if the touching operation is performed in the sleep mode. Since the display apparatus does not display images on a display panel in the sleep mode, a display controller, a gate driver and a source driver are suspended in operation.

When the sleep mode (pause mode) is transitioned to the normal operation mode (display mode) in the display apparatus disclosed in Japanese Unexamined Patent Application Publication No. 2017-91224, the display apparatus of the related art takes a longer time from detecting the touching operation (receiving a detection signal of the touching operation) until displaying an image on the display panel. Specifically, the display apparatus of the related art takes a longer time from receiving a control signal used to transition from the pause mode to the display mode until displaying an image on the display panel.

It is desirable to provide a display apparatus and a display system that may reduce time from when the control signal used to transition from the pause mode to the display mode to when an image is displayed on the display panel.

### SUMMARY

According to a first aspect of the disclosure, there is provided a display apparatus including: a display panel; a display driving circuit that supplies the display panel with a driving signal; a timing control circuit that supplies the display panel with an image signal and the display driving circuit with a timing signal; and a power control circuit that controls a power-on state and a power-off state on each of the display panel, the display driving circuit and the timing control circuit, wherein in response to reception of a control signal from a host controller with the control signal used to transition the display panel from a display mode causing the display panel to perform displaying to a pause mode causing the display panel to stop displaying, the timing control circuit transmits a pause signal to the power control circuit and causes the display driving circuit to stop supplying the driving signal to the display panel by stopping supplying the timing signal to the display driving circuit, wherein in response to reception of the pause signal, the power control circuit stops supplying at least part of power to be supplied to the display panel and the display driving circuit while keeping supplying power to the timing control circuit, and wherein in response to the reception of the control signal used to transition from the display mode to the pause mode from the host controller, the timing control circuit stops transmitting the pause signal to the power control circuit and supplies the display driving circuit with the timing signal.

According to a second aspect of the disclosure, there is provided a display system including: a display apparatus including a display panel; and a host controller that transmits a first control signal and a second control signal to the display apparatus with the first control signal used to transition the display panel from a display mode causing the display panel to perform displaying to a pause mode causing the display panel to stop displaying and with the second control signal used to transition the display panel from the pause mode to the display mode; wherein the display apparatus includes: a display driving circuit that supplies the display panel with a driving signal; a timing control circuit that supplies the display panel with an image signal and the display driving circuit with a timing signal; and a power control circuit that controls a power-on state and a power-off state on each of the display panel, the display driving circuit and the timing control circuit, wherein the timing control circuit receives the first control signal from the host controller, transmits a pause signal to the power control circuit, and causes the display driving circuit to stop supplying the driving signal to the display panel by stopping supplying the timing signal to the display driving circuit, wherein in response to reception of the pause signal, the power control circuit stops supplying at least part of power to be supplied to the display panel and the display driving circuit while keeping supplying power to the timing control circuit, and wherein in response to reception of the second control signal from the host controller, the timing control circuit stops transmitting the pause signal to the power control circuit and supplies the display driving circuit with the timing signal.

### BRIEF DESCRIPTION OF THE DRAWINGS

FIG. 1 is a block diagram of a display system of a first embodiment;

FIG. 2 schematically illustrates a configuration of a display panel;

FIG. 3 schematically illustrates a configuration of pixels in the display panel;

FIG. 4 is a functional block diagram of a timing control circuit and a power control circuit;

FIG. 5 is a functional block diagram of a display system serving as a comparative example;

FIG. 6 is a timing diagram illustrating an operation of the display system serving as the comparative example;

FIG. 7 is a timing diagram illustrating an operation of a display system of a first embodiment;

FIG. 8 is a block diagram illustrating a configuration of a display system of a second embodiment; and

FIG. 9 is a block diagram illustrating a configuration of a display system of a third embodiment.

### DESCRIPTION OF THE EMBODIMENTS

Embodiments of the disclosure are described with reference to the drawings. The disclosure is not limited to the embodiments described below. The embodiments may be appropriately modified without departing from the scope of the disclosure. In the discussion that follows, like elements or elements having the same function are designated with the same reference numerals throughout different drawings and the discussion thereof are not repeated. Configurations in the embodiments and modifications of the embodiments may be combined or changed without departing from the scope of the disclosure. For easier understanding, the configurations may be simplified or clarified in the drawings, and some of components in each configuration may be omitted.

### First Embodiment

### Whole Configuration of Display Apparatus

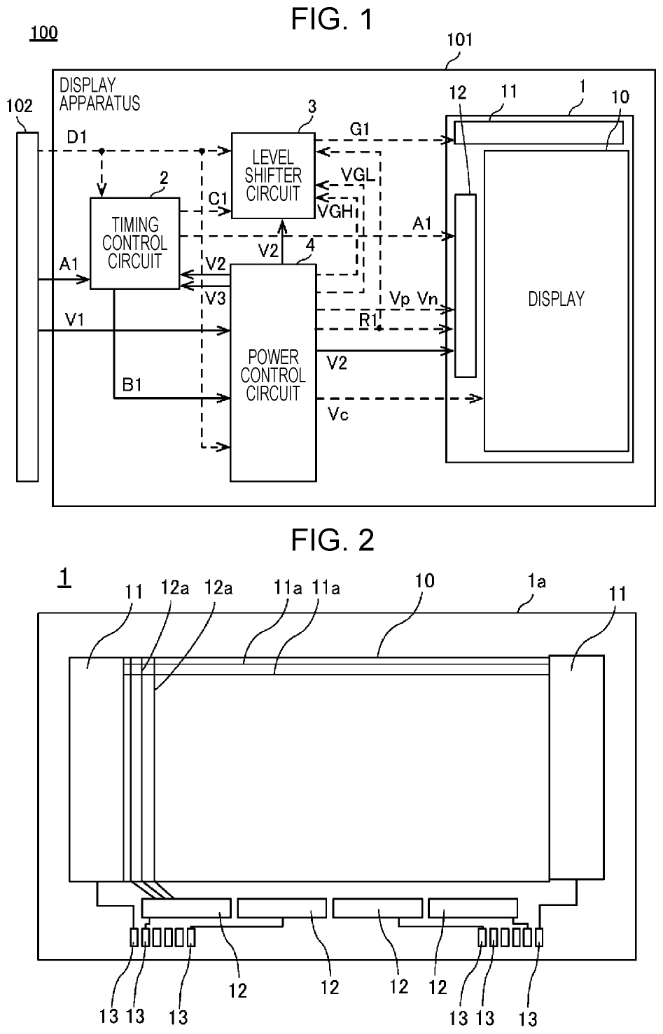

FIG. 1 is a block diagram of a display system 100 of a first embodiment. The display system 100 includes a display apparatus 101 and a host controller 102. The display system 100 may be a personal computer, a tablet terminal, a smart phone or a television device. The host controller 102 transmits to the display apparatus 101 not only an image signal (video signal) A1 but also a control signal D1. The host controller 102 is connected to the display apparatus 101 via an I2C bus and performs serial communication with the display apparatus 101. The display apparatus 101 displays an image in response to the image signal A1 from the host controller 102.

The control signal D1 includes a signal that commands a display panel 1 of the display apparatus 101 to transition from a display mode causing the display panel 1 to perform displaying to a pause mode causing the display panel 1 to stop displaying. For example, if no input is entered by a user for a specific period of time in the middle of a control operation in the display mode or the user is not present within a shooting range of a camera (not illustrated), the host controller 102 transmits the control signal D1 including the signal used to transition from the display mode to the pause mode. If an input is entered by the user in the middle of the control operation in the pause mode or the user appears within the shooting range of the camera, the host controller 102 transmits the control signal D1 including the signal used to transition from the pause mode to the display mode. According to the first embodiment, the host controller 102 supplies a power control circuit 4 with a voltage V1 regardless of whether the control operation is performed in the display mode or the pause mode.

The pause mode is a state in which the display panel 1 is caused to pause or stop displaying to reduce power consumption. The stopping of the displaying of the display panel 1 in the pause mode continues until the mode is transitioned to the display mode (the displaying is stopped across multiple frames). The stopping of the displaying signifies that the supply of signals (a gate signal and a gate driving signal) from a gate driving circuit 11 and a source driving circuit 12 to a display 10 is stopped in the display panel 1. The display mode is a state in which an image is displayed on the display panel 1 by supplying the signals (the gate signal and the gate driving signal) from the gate driving circuit 11 and the source driving circuit 12 to the display 10. Transmission of signals and supply of power denoted by arrow-headed broken lines in FIGS. 1, 4, 5, 8 and 9 are performed only in the display mode. The transmission of signals and the supply of power denoted by arrow-headed solid lines in FIGS. 1, 4, 5, 8 and 9 are performed in both the display mode and the pause mode.

### Configuration of Display Apparatus

As illustrated in FIG. 1, the display apparatus 101 includes a display panel 1, a timing control circuit 2, a level shifter circuit 3 and a power control circuit 4. The level shifter circuit 3 is an example of a “display driving circuit” in the disclosure.

### Configuration of Display Panel

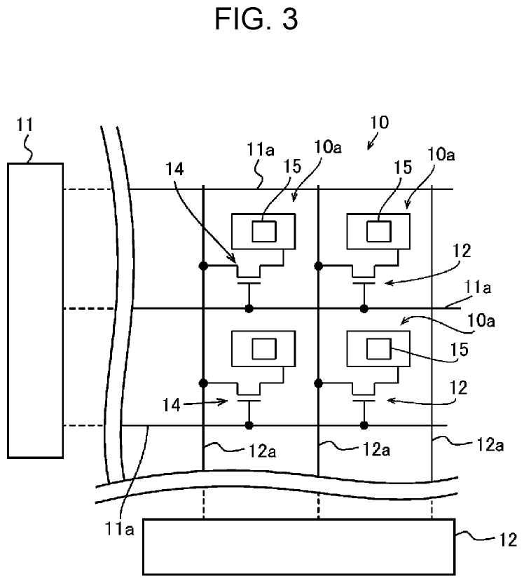

FIG. 2 schematically illustrates the configuration of the display panel 1. The display panel 1 displays images. For example, the display panel 1 may be a liquid-crystal display panel, an organic electroluminescent (EL) panel or a micro-light-emitting-diode (LED) panel. Referring to FIG. 2, the display panel 1 includes the display 10, the gate driving circuit 11 and the source driving circuit 12. The display panel 1 includes a substrate 1a that includes multiple gate lines 11a, multiple source lines 12a and multiple terminals 13 formed thereon. The gate lines 11a intersect the source lines 12a in a plan view. The display 10 is a region of the substrate 1a that has pixels 10a (see FIG. 3) formed thereon and displays images.

The gate driving circuit 11 successively supplies the gate lines 11a with a gate signal G1 from the level shifter circuit 3. The gate driving circuit 11 is a gate driver monolithic (GDM) circuit that is monolithically formed on the substrate 1a.

The source driving circuit 12 is supplied with an image signal A1 (digital signal) from the timing control circuit 2. The source driving circuit 12 is supplied from the power control circuit 4 with a positive voltage Vp, a negative voltage Vn and a reset signal R1. Using the positive voltage Vp and the negative voltage Vn, the source driving circuit 12 generates a source signal in response to the image signal A1 (digital signal). The source driving circuit 12 supplies the source signal to the source lines 12a. The source driving circuit 12 is an integrated circuit mounted on the substrate 1a.

The terminals 13 are connected to a flexible printed circuit board (not illustrated). The terminals 13 are connected to the timing control circuit 2, the level shifter circuit 3 and the power control circuit 4 via the flexible printed circuit board. The terminals 13 are also connected to the gate driving circuit 11, the source driving circuit 12 and a common electrode wiring (not illustrated).

FIG. 3 schematically illustrates the configuration of the pixels 10a on the display panel 1. Referring to FIG. 3, the pixels 10a are formed in a region delineated by the gate lines 11a and the source lines 12a. The pixel 10a includes a thin-film transistor 14 and a pixel electrode 15. The gate line 11a is connected to the gate electrode of the thin-film transistor 14. The source line 12a is connected to the source electrode of the thin-film transistor 14. The pixel electrode 15 is connected to the drain electrode of the thin-film transistor 14. When the gate electrode of the thin-film transistor 14 is supplied with a gate signal from the gate line 11a, the pixel electrode 15 is supplied with a source signal and is charged (thus with an image written on the pixel electrode 15).

### Configuration of Timing Control Circuit

Referring to FIG. 1, the timing control circuit 2 receives the control signal D1 and the image signal A1 from the host controller 102. The timing control circuit 2 supplies the display panel 1 with the image signal A1 and the level shifter circuit 3 with a timing signal C1. For example, the timing control circuit 2 may be an integrated circuit.

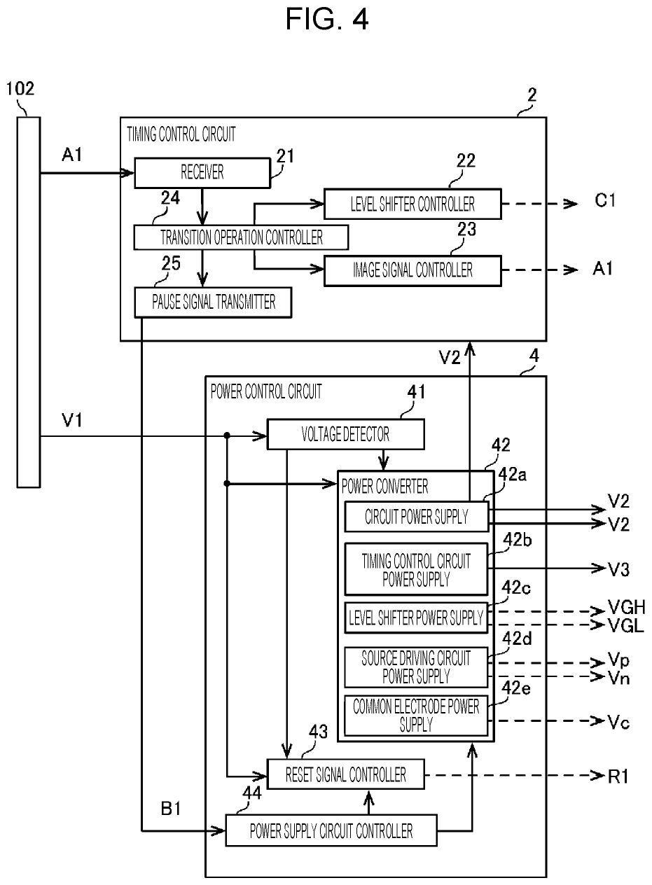

FIG. 4 is the functional block diagram of the timing control circuit 2 and the power control circuit 4. Referring to FIG. 4, the timing control circuit 2 includes a receiver 21, a level shifter controller 22, an image signal controller 23, a transition operation controller 24 and a pause signal transmitter 25. The receiver 21 receives the image signal A1 and the control signal D1 from the host controller 102. The level shifter controller 22 transmits the timing signal C1 to the level shifter circuit 3 in response to the image signal A1. The timing signal C1 includes a synchronization signal (such as a vertical synchronization signal) and a clock signal. The image signal controller 23 transmits the image signal A1 to the source driving circuit 12 in the display panel 1.

When the receiver 21 receives the control signal D1 including a signal used to transition from the display mode to the pause mode, the transition operation controller 24 causes the level shifter controller 22 and the image signal controller 23 to stop operating. The supply of the timing signal C1 from the level shifter controller 22 is thus stopped. Stopping the supply of the timing signal C1 causes the gate driving circuit 11 to stop outputting the gate signal. The image signal controller 23 stops supplying the image signal A1. The source driving circuit 12 thus stops outputting the source signal. The transition operation controller 24 transmits to the pause signal transmitter 25 a signal that commands the pause signal transmitter 25 to transmit the pause signal B1.

When the receiver 21 receives the control signal D1 including a signal used to transition from the pause mode to the display mode, the transition operation controller 24 causes the level shifter controller 22 and the image signal controller 23 to start operating (resume operation). The level shifter controller 22 thus starts supplying the timing signal C1. The start of supplying the timing signal C1 causes the gate driving circuit 11 to start outputting the gate signal. The image signal controller 23 also starts supplying the image signal A1. The source driving circuit 12 starts outputting the source signal. The transition operation controller 24 transmits to the pause signal transmitter 25 a signal that commands the pause signal transmitter 25 to stop transmitting the pause signal B1.

In response to the command from the transition operation controller 24, the pause signal transmitter 25 transmits the pause signal B1 to the power control circuit 4. For example, the pause signal transmitter 25 transmits the pause signal B1 by transitioning to a high level the level of a voltage applied to a signal line connected to the power control circuit 4. In response to the command from the transition operation controller 24, the pause signal transmitter 25 stops transmitting the pause signal B1 by transitioning to a low level the level of the voltage applied to the signal line connected to the power control circuit 4.

### Configuration of Level Shifter Circuit

The level shifter circuit 3 generates the gate signal G1 responsive to the timing signal C1 from the timing control circuit 2 in the display mode using voltages VGH and VGL supplied from the power control circuit 4. Via the gate driving circuit 11, the level shifter circuit 3 successively transmits to the gate lines 11a the pulse-shaped gate signal G1 at the voltage VGH. The level shifter circuit 3 also supplies the voltage VGL to gate lines 11a excluding the gate lines 11a that are currently supplied with the gate signal G1.

### Configuration of Power Control Circuit

The power control circuit 4 controls a power-on state and a power-off state of each of the display panel 1, the timing control circuit 2 and the level shifter circuit 3. Referring to FIG. 4, the power control circuit 4 includes a voltage detector 41, a power converter 42, a reset signal controller 43 and a power supply circuit controller 44.

The voltage detector 41 detects a voltage V1 (at a high voltage level) supplied by the host controller 102. When the host controller 102 stops supplying the voltage V1 (with the voltage level transitioned to a low level), the voltage detector 41 causes the reset signal controller 43 to stop outputting the reset signal R1. When the host controller 102 stops supplying the voltage V1, the voltage detector 41 also causes the power converter 42 to stop outputting voltages. For example, the supply of the voltage V1 from the host controller 102 is stopped when the display system 100 is powered off and the host controller 102 is thus powered off.

The power converter 42 includes a circuit power supply 42a, a timing control circuit power supply 42b, a level shifter power supply 42c, a source driving circuit power supply 42d and a common electrode power supply 42e. The circuit power supply 42a converts the voltage V1 output from the host controller 102 to a voltage V2 that is used to operate the display panel 1, the timing control circuit 2 and the level shifter circuit 3. The circuit power supply 42a outputs the voltage V2 to the display panel 1, the timing control circuit 2 and the level shifter circuit 3. For example, the voltage V1 is 3.3 V and the voltage V2 is 1.8 V.

The timing control circuit power supply 42b converts the voltage V1 output from the host controller 102 into a voltage V3 used to operate the timing control circuit 2. The timing control circuit power supply 42b outputs the voltage V3 to the timing control circuit 2. The voltage V3 is different in voltage value from the voltage V2.

The level shifter power supply 42c converts the voltage V1 output from the host controller 102 into the voltages VGH and VGL that the level shifter circuit 3 uses to generate the gate signal G1. The level shifter power supply 42c outputs the voltages VGH and VGL to the level shifter circuit 3.

The source driving circuit power supply 42d converts the voltage V1 output from the host controller 102 into the positive voltage Vp and the negative voltage Vn that the source driving circuit 12 uses to generate the source signal. The source driving circuit power supply 42d outputs the positive voltage Vp and the negative voltage Vn to the source driving circuit 12.

The common electrode power supply 42e converts the voltage V1 output from the host controller 102 into a voltage Vc that is supplied to the common electrode of the display panel 1. The common electrode power supply 42e outputs the voltage Vc to the display panel 1.

The reset signal controller 43 outputs the reset signal R1 in response to a command from the voltage detector 41. When the reset signal R1 transitions to a low voltage level (off) from a high voltage level, the level shifter circuit 3 and the source driving circuit 12 stop operating. Specifically, the level shifter circuit 3 (the gate driving circuit 11) outputs the gate signal with the reset signal R1 at a high voltage level while stopping outputting the gate signal with the reset signal R1 at a low voltage level. The source driving circuit 12 outputs the source signal with the reset signal R1 at a high voltage level and while stopping outputting the source signal with the reset signal R1 at a low voltage level.

With the pause signal B1 received from the timing control circuit 2, the power supply circuit controller 44 causes the level shifter power supply 42c, the source driving circuit power supply 42d and the common electrode power supply 42e to stop supplying power while allowing the circuit power supply 42a and the timing control circuit power supply 42b in the power converter 42 to continuously supply power. In this way, the level shifter circuit 3, not supplied with power from the level shifter power supply 42c, stops the operation thereof (thus stopping outputting the gate signal). The supply of power to the common electrode in the display panel 1 is also stopped. The source driving circuit 12, not supplied with power by the level shifter power supply 42c, stops the operation thereof (thus stopping outputting the source signal). The supply of power to timing control circuit 2 is maintained. Time to start up the timing control circuit 2 may be saved between when the control signal D1 including the signal used to transition from the pause mode to the display mode is received and when the display panel 1 displays images. As a result, a period of time from when the control signal D1 used to transition from the pause mode to the display mode is received until when the display panel 1 displays images may be reduced.

### Operation of Display System

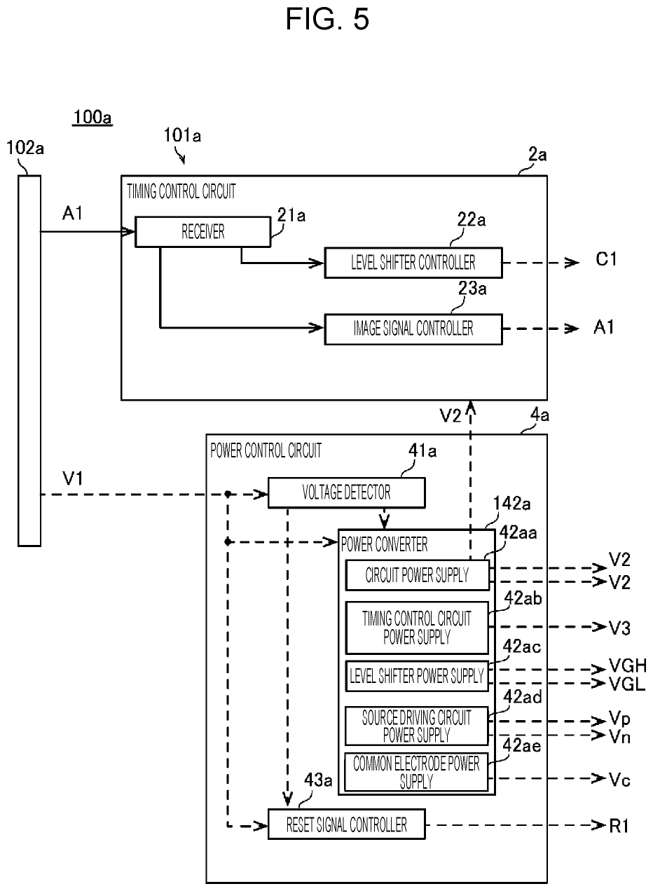

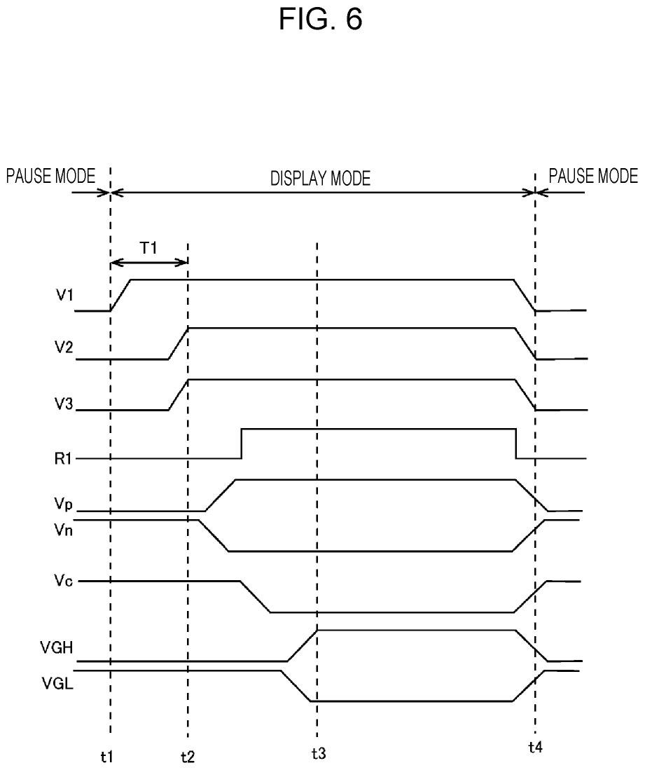

Operation of the display system 100 of the first embodiment is described in comparison with a display system 100a as a comparative example. FIG. 5 is a functional block diagram of a configuration of the display system 100a as the comparative example. FIG. 6 is a timing diagram illustrating the operation of the display system 100a.

### COMPARATIVE EXAMPLE

Referring to FIG. 5, the display system 100a includes a display apparatus 101a and a host controller 102a. A receiver 21a in a timing control circuit 2a receives the image signal A1 from the host controller 102a. A level shifter controller 22a in the timing control circuit 2a outputs the timing signal C1 in response to the image signal A1. An image signal controller 23a in the timing control circuit 2a outputs the image signal A1 to the source driving circuit.

When the mode is transitioned from the display mode to the pause mode, the host controller 102a stops supplying the voltage V1 to a power control circuit 4a. When the supply of the voltage V1 to a voltage detector 41a is stopped, the voltage detector 41a in the power control circuit 4a causes a power converter 142a to stop operating and thus causes a reset signal controller 43a to stop outputting the reset signal R1 (thus transitioning the voltage of the reset signal R1 to a low level). In the comparative example in the pause mode, the supply of power to the timing control circuit 2a, the level shifter circuit and the display panel is thus stopped.

When the mode is transitioned from the pause mode to the display mode, the host controller 102a starts supplying the voltage V1 to the power control circuit 4a at time t1 as illustrated in FIG. 6. The power control circuit 4a starts up and then the outputting of the voltages V2 and V3 starts after the elapse of a time duration of T1 from time t1. Then the timing control circuit 2a starts up. The outputting of the voltages Vp, Vn, Vc, VGH and VGL and the reset signal R1 starts and at time t3, the display panel starts displaying images.

### Operation of First Embodiment

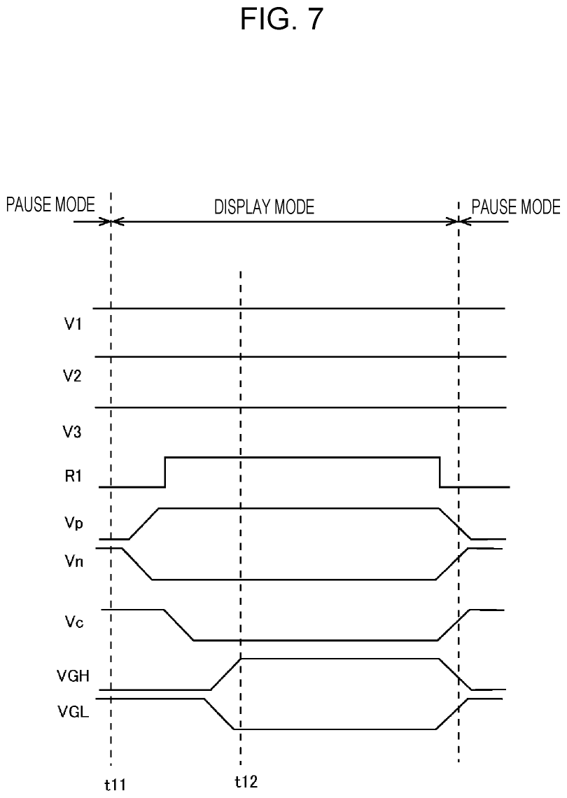

In the first embodiment in contrast with the comparative example, the host controller 102 supplies the voltage V1 to the power control circuit 4 in both the pause mode and the display mode as illustrated in FIG. 7. When the mode is transitioned from the pause mode to the display mode, the host controller 102 transmits to the timing control circuit 2 the control signal D1 including the signal used to transition from the pause mode to the display mode. The timing control circuit 2 starts supplying the timing signal C1 to the level shifter circuit 3 and the image signal A1 to the source driving circuit 12.

The timing control circuit 2 stops supplying the pause signal B1 to the power control circuit 4 at time t11. Since the power control circuit 4 supplied with the voltage V1 continues outputting the voltages V2 and V3 in the pause mode, the voltages V2 and V3 still continues to be output at time t11. The power control circuit 4 supplied with the voltage V1 starts outputting the voltages Vp, Vn, Vc, VGH and VGL and the reset signal R1 after time t11 and the display panel 1 starts the displaying operation at time t12. According to the first embodiment, the display panel 1 may start the displaying operation within a period of time that starts from the time of transition from the pause mode to the display mode and is shorter than the corresponding period of time in the comparative example by a time duration T1.

### Second Embodiment

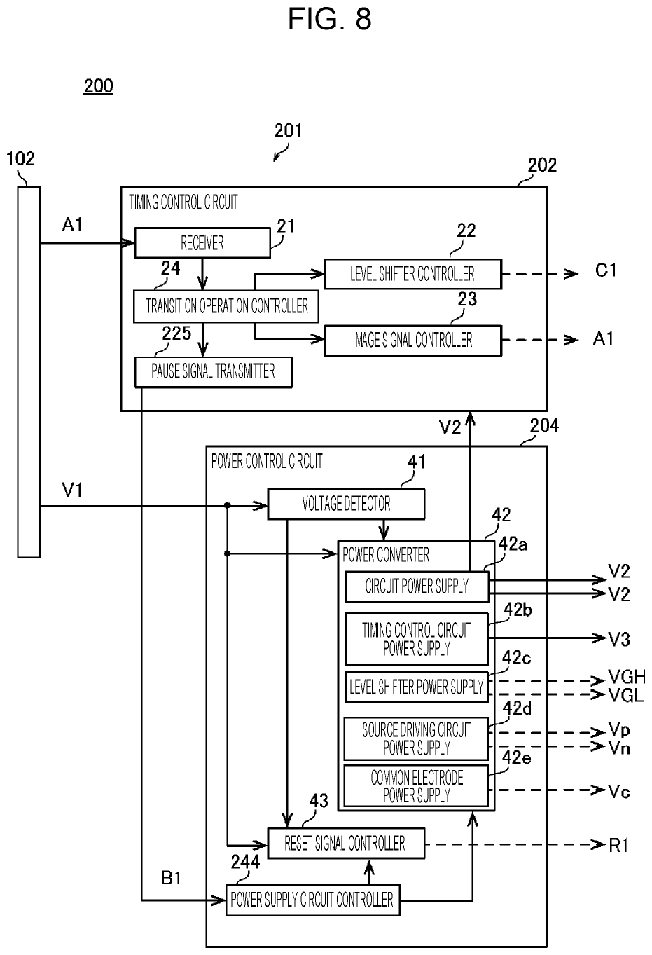

The configuration of a display system 200 of a second embodiment is described with reference to FIG. 8. In the first embodiment, the pause signal B1 is transmitted by transitioning a single signal line to a high voltage level or a low voltage level. In the second embodiment, the pause signal B1 is transmitted in response to a command. The same elements identical to those in the first embodiment are designated with the same reference numerals and the discussion thereof is omitted herein.

Referring to FIG. 8, the display system 200 includes a display apparatus 201. The display apparatus 201 includes a timing control circuit 202 and a power control circuit 204. In the second embodiment, the timing control circuit 202 is connected to the power control circuit 204 via an I2C bus and performs serial communication with the power control circuit 204. A pause signal transmitter 225 in the timing control circuit 202 transmits the pause signal B1 as a command in the serial communication. In response to the reception of a command, a power supply circuit controller 244 in the power control circuit 204 causes the level shifter power supply 42c, the source driving circuit power supply 42d and the common electrode power supply 42e to stop supplying power while keeping the circuit power supply 42a and the timing control circuit power supply 42b in the power converter 42 supplying power. The rest of the configuration and effects of the second embodiment remains unchanged from the configuration and effects of the first embodiment.

### Third Embodiment

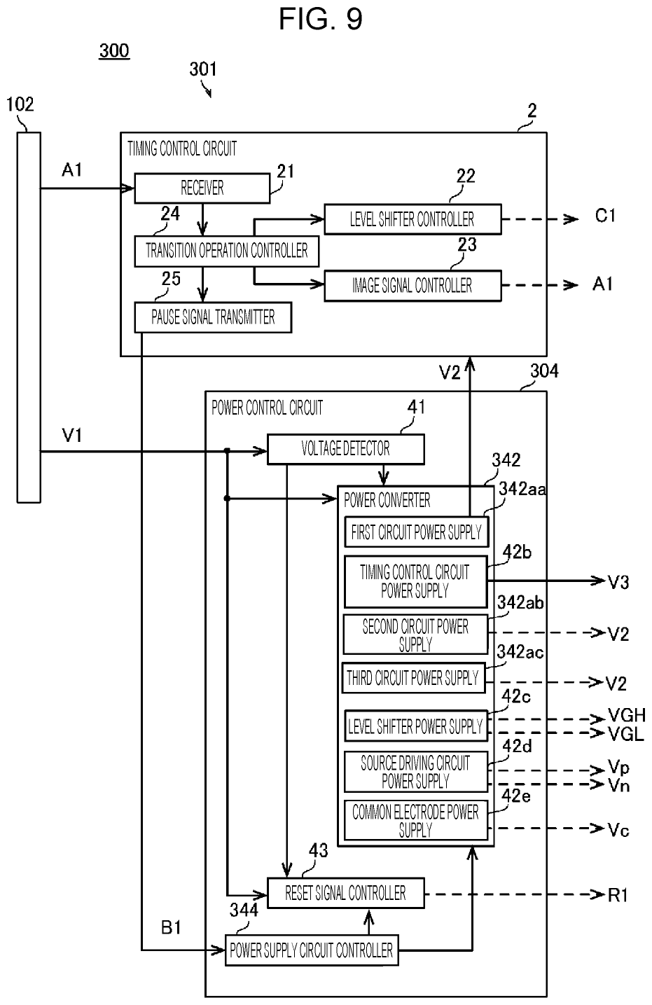

Referring to FIG. 9, the configuration of a display system 300 of a third embodiment is described below. According to the third embodiment, in response to the reception of the pause signal B1, the power control circuit 204 continues to supplying power to the timing control circuit 2 but stops supplying power to the display panel 1, the level shifter circuit 3 and the source driving circuit 12. Elements of the third embodiment identical to the elements of the first embodiment are designated with the same reference numerals and the discussion thereof is omitted herein.

As illustrated in FIG. 9, the display system 300 includes a display apparatus 301. The display apparatus 301 includes a power control circuit 304. The power control circuit 304 includes a power converter 342 and a power supply circuit controller 344. The power converter 342 of the third embodiment includes a first circuit power supply 342aa, a second circuit power supply 342ab and a third circuit power supply 342ac.

The first circuit power supply 342aa is connected to the timing control circuit 2 and supplies the voltage V2 to the timing control circuit 2 in both the display mode and the pause mode. The second circuit power supply 342ab is connected to the level shifter circuit 3 (see FIG. 1) and supplies the voltage V2 to the level shifter circuit 3 in the display mode while stopping supplying power the voltage V2 to the level shifter circuit 3 in the pause mode. The third circuit power supply 342ac is connected to the source driving circuit 12 (see FIG. 1) and supplies the voltage V2 to the source driving circuit 12 in the display mode while stopping supplying the voltage V2 to the source driving circuit 12 in the pause mode.

In response to the reception of the pause signal B1 from the timing control circuit 2, the power supply circuit controller 344 causes the second circuit power supply 342ab, the third circuit power supply 342ac, the level shifter power supply 42c, the source driving circuit power supply 42d and the common electrode power supply 42e to stop supplying power while keeping the first circuit power supply 342aa and the timing control circuit power supply 42b supplying power. The power control circuit 304 stops supplying power to the display panel 1, the level shifter circuit 3 and the source driving circuit 12 while keeping supplying power to the timing control circuit 2. In this way, the supply of power to the display panel 1, the level shifter circuit 3 and the source driving circuit 12 is stopped and power consumption in the pause mode may be reduced.

### Modifications

The embodiments of the disclosure have been described for exemplary purposes only. The disclosure is not limited to the embodiments and the embodiments may be modified without departing from the scope of the disclosure. Modifications of the embodiments are described below.
(1) According to the first through third embodiments, the host controller supplies the voltage V1 to the power control circuit. The disclosure is not limited to this method. A power supply circuit other than the host controller may supply the voltage V1 to the power control circuit.
(2) According to the first through third embodiments, the display panel includes the gate driver monolithic (GDM) circuit. The disclosure is not limited to this configuration. For example, an integrated circuit (gate driver) including a level shifter circuit may be mounted on the substrate.
(3) According to the first through third embodiments, the display driving circuit includes the level shifter circuit. The disclosure is not limited to this configuration. The display driving circuit may not include the level shifter circuit but may include a driving circuit in which the gate signal is successively supplied to multiple gate lines.

The configurations described above may also be described as below.

According to a first configuration, there is provided a display apparatus including: a display panel; a display driving circuit that supplies the display panel with a driving signal; a timing control circuit that supplies the display panel with an image signal and the display driving circuit with a timing signal; and a power control circuit that controls a power-on state and a power-off state on each of the display panel, the display driving circuit and the timing control circuit, wherein in response to reception of a control signal from a host controller with the control signal used to transition the display panel from a display mode causing the display panel to perform displaying to a pause mode causing the display panel to stop displaying, the timing control circuit transmits a pause signal to the power control circuit, and causes the display driving circuit to stop supplying the driving signal to the display panel by stopping supplying the timing signal to the display driving circuit, wherein in response to reception of the pause signal, the power control circuit stops supplying at least part of power to be supplied to the display panel and the display driving circuit while keeping supplying power to the timing control circuit, and wherein in response to reception of a control signal used to transition from the display mode to the pause mode from the host controller, the timing control circuit stops transmitting the pause signal to the power control circuit and supplies the display driving circuit with the timing signal (first configuration).

According to the first configuration, the supply of power to the timing control circuit is maintained while the display panel stops displaying. Time to start up the timing control circuit may be saved between when the control signal used to transition from the pause mode to the display mode is received and when the display panel stops displaying. As a result, a period of time from when the control signal used to transition from the pause mode to the display mode is received until when the display panel displays an image may be reduced.

In the first configuration, the power control circuit may include a first power supply circuit supplying power at a first voltage to the timing control circuit, the display panel and the display driving circuit, a second power supply circuit supplying power at a second voltage to the display panel and a third power supply circuit supplying power at a third voltage to the display driving circuit. In response to the reception of the pause signal, the power control circuit may cause the second power supply circuit and the third power supply circuit to stop supplying power while keeping the first power supply circuit supplying power (second configuration).

In the second configuration, the second power supply circuit and the third power supply circuit stop supplying power while the first power supply circuit supplies power to the timing control circuit. The supply of part of the power to be supplied to the display panel and the display driving circuit may be stopped while the supply of power to the timing control circuit is maintained.

In the first configuration, the power control circuit may be configured such that in response to the reception of the pause signal, the power control circuit stops supplying power to the display panel and the display driving circuit while keeping supplying power to the timing control circuit (third configuration).

According to the third configuration, power consumption may be reduced since the supply of power to the display panel and the display driving circuit is suspended in the pause mode.

According to a fourth configuration, there is provided a display system including: a display apparatus including a display panel; and a host controller that transmits a first control signal and a second control signal to the display apparatus with the first control signal used to transition the display panel from a display mode causing the display panel to perform displaying to a pause mode causing the display panel to stop displaying and with the second control signal used to transition the display panel from the pause mode to the display mode; wherein the display apparatus includes: a display driving circuit that supplies the display panel with a driving signal; a timing control circuit that supplies the display panel with an image signal and the display driving circuit with a timing signal; and a power control circuit that controls a power-on state and a power-off state on each of the display panel, the display driving circuit and the timing control circuit, wherein the timing control circuit receives the first control signal from the host controller, transmits a pause signal to the power control circuit, and causes the display driving circuit to stop supplying the driving signal to the display panel by stopping supplying the timing signal to the display driving circuit, wherein in response to reception of the pause signal, the power control circuit stops supplying at least part of power to be supplied to the display panel and the display driving circuit while keeping supplying power to the timing control circuit, and wherein in response to reception of the second control signal from the host controller, the timing control circuit stops transmitting the pause signal to the power control circuit and supplies the display driving circuit with the timing signal (fourth configuration).

According to the fourth configuration, the display system thus provided may reduce a period of time from when the control signal used to transition from the pause mode to the display mode is received until when the display panel displays an image.

The present disclosure contains subject matter related to that disclosed in Japanese Priority Patent Application JP 2023-119440 filed in the Japan Patent Office on Jul. 21, 2023, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a display panel;
a display driving circuit that supplies the display panel with a driving signal;
a timing control circuit that supplies the display panel with an image signal and the display driving circuit with a timing signal; and
a power control circuit that controls a power-on state and a power-off state on each of the display panel, the display driving circuit and the timing control circuit,
wherein in response to reception of a control signal from a host controller with the control signal used to transition the display panel from a display mode causing the display panel to perform displaying to a pause mode causing the display panel to stop displaying, the timing control circuit transmits a pause signal to the power control circuit, and
causes the display driving circuit to stop supplying the driving signal to the display panel by stopping supplying the timing signal to the display driving circuit,
wherein in response to reception of the pause signal, the power control circuit stops supplying at least part of power to be supplied to the display panel and the display driving circuit while keeping supplying power to the timing control circuit, and
wherein in response to the reception of a control signal used to transition from the display mode to the pause mode from the host controller, the timing control circuit stops transmitting the pause signal to the power control circuit and
supplies the display driving circuit with the timing signal.

2. The display apparatus according to claim 1, wherein the power control circuit comprises a first power supply circuit supplying power at a first voltage to the timing control circuit, the display panel and the display driving circuit, a second power supply circuit supplying power at a second voltage to the display panel and a third power supply circuit supplying power at a third voltage to the display driving circuit,
wherein in response to the reception of the pause signal, the power control circuit causes the second power supply circuit and the third power supply circuit to stop supplying power while keeping the first power supply circuit supplying power.

3. The display apparatus according to claim 1, wherein in response to the reception of the pause signal, the power control circuit stops supplying power to the display panel and the display driving circuit while keeping supplying power to the timing control circuit.

4. A display system comprising:
a display apparatus including a display panel; and
a host controller that transmits a first control signal and a second control signal to the display apparatus with the first control signal used to transition the display panel from a display mode causing the display panel to perform displaying to a pause mode causing the display panel to stop displaying and with the second control signal used to transition the display panel from the pause mode to the display mode;
wherein the display apparatus includes:
a display driving circuit that supplies the display panel with a driving signal;
a timing control circuit that supplies the display panel with an image signal and the display driving circuit with a timing signal; and
a power control circuit that controls a power-on state and a power-off state on each of the display panel, the display driving circuit and the timing control circuit,
wherein the timing control circuit
receives the first control signal from the host controller,
transmits a pause signal to the power control circuit and
causes the display driving circuit to stop supplying the driving signal to the display panel by stopping supplying the timing signal to the display driving circuit,
wherein in response to reception of the pause signal, the power control circuit stops supplying at least part of power to be supplied to the display panel and the display driving circuit while keeping supplying power to the timing control circuit, and
wherein in response to reception of the second control signal from the host controller, the timing control circuit stops transmitting the pause signal to the power control circuit and
supplies the display driving circuit with the timing signal.
